(19) United States
(12) Patent Application Publication
(10) Pub. No.: US 2023/0289837 A1
(43) Pub. Date: Sep. 14, 2023

(54) COMPUTERIZED SYSTEMS AND METHODS FOR AUTOMATED PERFORMANCE OF GROWING BASELINE ASSESSMENTS

(71) Applicant: WORKDAY, INC., Pleasanton, CA (US)

(72) Inventors: Henrik KAERSGAARD, Copenhagen (DK); Andreas LIND, Copenhagen (DK)

(21) Appl. No.: 17/693,753

(22) Filed: Mar. 14, 2022

(51) Int. Cl. G06Q 30/02

(52) U.S. Cl. CPC G06Q 30/0203

(57) ABSTRACT

Disclosed are systems and methods for an assessment framework that operates to dynamically generate customized surveys for recipient-respondent pairs. The customized surveys can have curated questions dynamically selected and/or provided from recipients based on, but not limited to, which recipients a respondent should give feedback to, how many questions the respondent should answer, and which questions in particular, the respondent should answer. The disclosed framework can automatically and dynamically customize surveys for individual respondents, and/or sets of respondents, according to the selected questions included therein and/or from which recipients they are sent from (or on their behalf).

### BACKGROUND

Surveys serve as important resources for entities (e.g., companies) and their managers to collect information from parties (e.g., users or employees, referred to as respondents). In certain circumstances, surveys can be used to drive productivity and enable better decision making.

Current solutions for engaging survey participation from a plurality of networked sources are deficient in that they focus on probabilistic modelling based on past user behaviors in order to predict how respondents will engage, if at all.

### SUMMARY

Presently known systems fall short of establishing end-to-end (E2E) solutions that capitalize on real-time data analytics and respondent data that enables customized assessments to be compiled and deployed thereby triggering improved respondent engagement, and enhances big data collection for purposes of optimizing system resources.

The systems and methods disclosed herein provide an improved distributed, E2E assessment framework. The disclosed assessment framework, as discussed in more detail below, is configured to dynamically generate surveys based on two forms of criteria: question selection and question distribution. These criteria enable the framework to formulate and distribute surveys to respondents that have questions that account for: i) which recipients (which is a user that provides or selects questions for a survey and receives the answers) if any a respondent should give feedback to, ii) how many questions the respondent should answer, and iii) which questions in particular, the respondent should answer.

According to some embodiments, the framework operates by performing a dynamic determination of question selection and question distribution. In some embodiments, as discussed in more detail below, question selection corresponds to a determination of which recipients a respondent gives feedback to in a given round, which also provides a basis for a determination of how many questions a respondent should answer for each recipient in a given round. In some embodiments, question distribution corresponds to a determination of which questions in particular should be included in a survey round. In other words, which questions should a survey include that the respondent will answer for a given recipient (e.g., whether the respondent gets the baseline survey for a recipient).

Thus, according to some embodiments, rounds (or iterations) of surveys can be distributed to a set of users. As discussed in more detail below, the types of questions, quantity of questions, and source of questions (e.g., which recipient is sending a respondent a question) can be dynamically determined, which can drive how surveys are compiled for each respondent. In some embodiments, surveys can be dynamically customized for individual respondents, and/or sets of respondents (e.g., departments within a company).

In accordance with one or more embodiments, the present disclosure provides computerized methods for an assessment framework that dynamically determines and distributes surveys to sets of users that include personalized and quantified questions therein.

In accordance with one or more embodiments, the present disclosure provides a non-transitory computer-readable storage medium for carrying out the above mentioned technical steps of the framework’s functionality. The non-transitory computer-readable storage medium has tangibly stored thereon, or tangibly encoded thereon, computer readable instructions that when executed by a device (e.g., a client device) cause at least one processor to perform a method for an assessment framework that dynamically determines and distributes surveys to sets of users that include personalized and quantified questions therein.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary data flow according to some embodiments of the present disclosure; and

FIG. 4 is a block diagram illustrating a computing device showing an example of a client or server device used in various embodiments of the present disclosure.

### DETAILED DESCRIPTION OF EXAMPLE EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device, referred to as user equipment (UE)), may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device (UE) may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

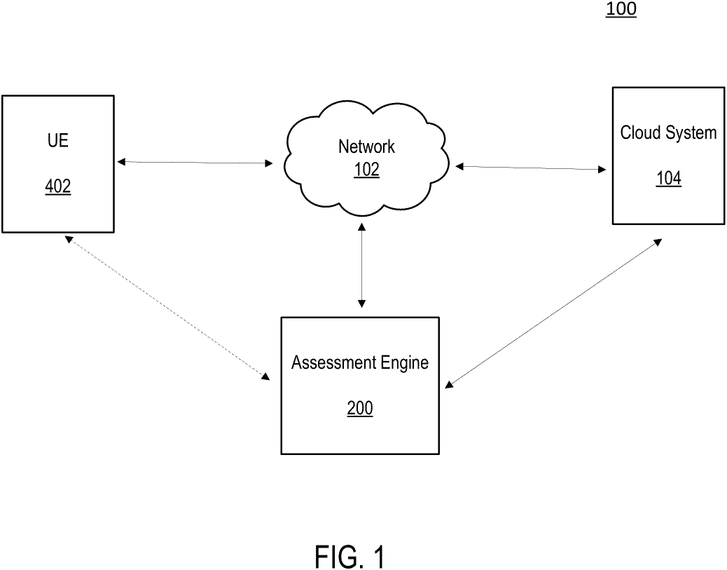

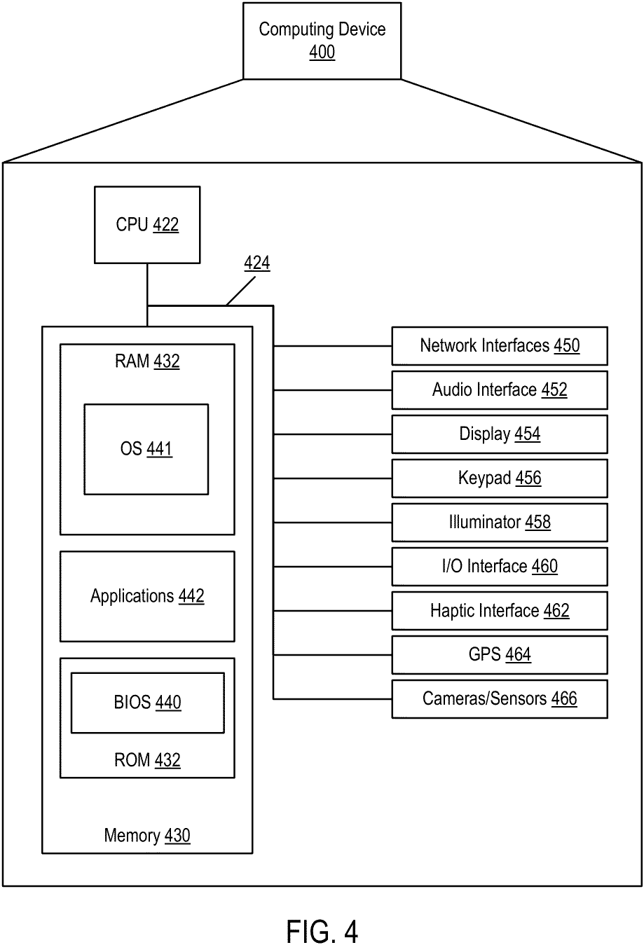

With reference to FIG. 1, system 100 is depicted which includes UE 402 (e.g., a client device, as mentioned above), network 102, cloud system 104 and assessment engine 200. UE 402 can be any type of device, such as, but not limited to, a mobile phone, tablet, laptop, sensor, Internet of Things (IoT) device, autonomous machine, and any other device equipped with a cellular or wireless or wired transceiver. Further discussion of UE 402 is provided below in reference to FIG. 4.

Network 102 can be any type of network, such as, but not limited to, a wireless network, cellular network, the Internet, and the like (as discussed above). Network 102 facilitates connectivity of the components of system 100, as illustrated in FIG. 1.

Cloud system 104 can be any type of cloud operating platform and/or network based system upon which applications, operations, and/or other forms of network resources can be located. For example, system 104 can be a service provider and/or network provider from where services and/or applications can be accessed, sourced or executed from. In some embodiments, cloud system 104 can include a server(s) and/or a database of information which is accessible over network 102. In some embodiments, a database (not shown) of cloud system 104 can store a dataset of data and metadata associated with local and/or network information related to a user(s) of UE 402 and the UE 402, and the services and applications provided by cloud system 104 and/or assessment engine 200.

Assessment engine 200, as discussed above and below in more detail, includes components for optimizing how surveys or assessments are compiled and distributed to participating users. According to some embodiments, assessment engine 200 can be a special purpose machine or processor and could be hosted by a device on network 102, within cloud system 104 and/or on UE 402. In some embodiments, engine 200 can be hosted by a peripheral device connected to UE 402.

According to some embodiments, as discussed above, assessment engine 200 can function as an application provided by cloud system 104. In some embodiments, engine 200 can function as an application installed on UE 402. In some embodiments, such application can be a web-based application accessed by UE 402 over network 102 from cloud system 104 (e.g., as indicated by the connection between network 102 and engine 200, and/or the dashed line between UE 402 and engine 200 in FIG. 1). In some embodiments, engine 200 can be configured and/or installed as an augmenting script, program or application (e.g., a plug-in or extension) to another application or program provided by cloud system 104 and/or executing on UE 402.

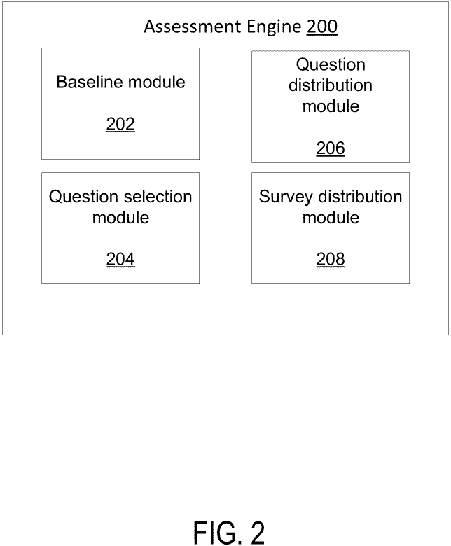

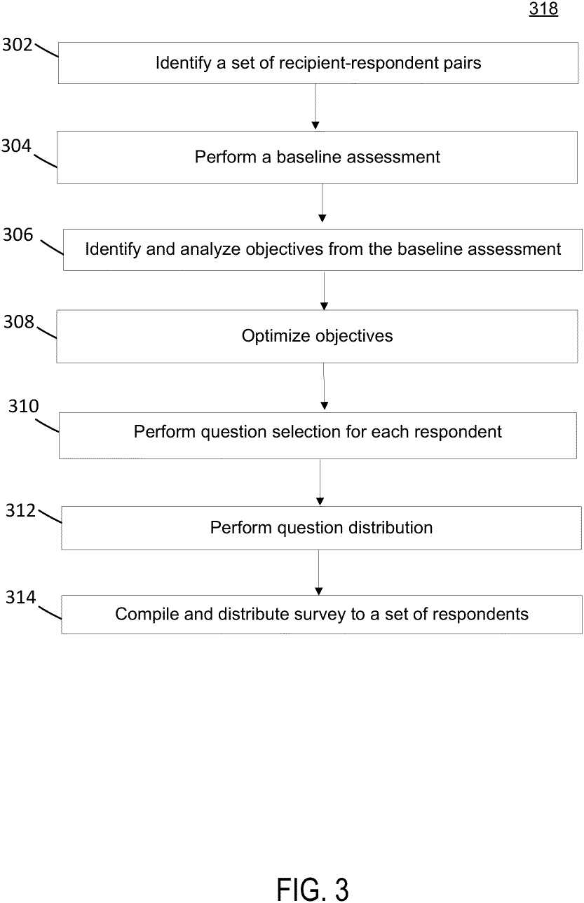

As illustrated in FIG. 2, according to some embodiments, assessment engine 200 includes baseline module 202, question selection module 204, question distribution module 206 and survey distribution module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below in relation to FIG. 3.

FIG. 3 provides Process 300 which details non-limiting example embodiments of the disclosed assessment framework’s operations of dynamically generating customized surveys for respondents. As discussed herein, customized surveys can have curated questions dynamically selected and/or provided from recipients based on, but not limited to, which recipients a respondent should give feedback to, how many questions the respondent should answer, and which questions in particular, the respondent should answer. Thus, as discussed below, Process 300 provides example embodiments of surveys that are dynamically customized for individual respondents, and/or sets of respondents (e.g., departments within a company), according to the selected questions included therein and/or from which recipients they are sent from (or on their behalf).

According to some embodiments, Steps 302-304 of Process 300 can be performed by baseline module 202 of assessment engine 200; Steps 306-310 can be performed by question selection module 202; Step 312 can be performed by question distribution module 206; and Step 314 can be performed by survey distribution module 208.

Process 300 begins with Step 302 where a set of recipient-respondent pairs are identified. According to some embodiments, a recipient-respondent pair involves a recipient, which is a user that provides or selects questions for a survey and receives the answers (e.g., a completed survey), and a respondent, which as discussed above, is the answering user to the posited questions in the survey. For example, a recipient-respondent pair can include a Human Resource (HR) manager and an employee at a company, respectively.

According to some embodiments, the set of recipient-respondent pairs can involve a recipient, and a set of respondents selected from a predefined group. For example, a recipient can be paired with employees within a specific department of a company.

According to some embodiments, each respondent within the identified set of recipient-respondent pairs can have a question budget set, which limits the total number of questions each respondent can be asked by the total of recipients. For example, if a respondent is paired with 2 recipients, and the budget is X questions for the respondent, then each recipient may only be able to ask the recipient their share of X questions (e.g., X/2).

According to some embodiments, a question budget can vary dependent on a feedback cadence (e.g., how often a respondent is asked to respond to a survey). In some embodiments, a feedback cadence can correspond to a predetermined time period, for example: weekly, bi-weekly, monthly, quarterly, yearly, and the like.

Thus, in some embodiments, dependent on the feedback cadence and the question budget, the number of questions within a survey round (or per iteration) can be further limited. For example, if the question budget for a respondent is 48 questions per year, and the feedback cadence is quarterly, the respondent may only be asked 12 questions per time they are issued a survey to respond to.

In Step 304, a baseline assessment for each recipient-respondent pair is performed. According to some embodiments, a baseline assessment includes a set of questions put forth on behalf of the recipient for which the respondent has a predetermined time to answer (e.g., 2 weeks). In some embodiments, the survey of the baseline assessment can comprise a criteria that requires all of its questions be answered. In some embodiments, the questions included in the baseline assessment can be randomly selected (e.g., by a randomization algorithm executing in conjunction with engine 200); and in some embodiments, the recipient can select at least a portion or all of the questions.

In some embodiments, the baseline assessment can serve as an initial survey between a recipient-respondent pair. In some embodiments, if a respondent-recipient pair has already been subject to a baseline assessment, then engine 200 may retrieve the information from the previously issued baseline assessment rather than reiterate a survey between the established pair. In some embodiments, the baseline assessment may still be performed despite the pair being an established pair having interacted via a baseline assessment survey prior to the performance of Step 304.

According to some embodiments, Step 304 can involve determining that a predetermined number of questions in a survey outstanding between a recipient-respondent pair are outstanding. For example, if a respondent has yet to answer 70% of questions put forth by a recipient, then Step 304 can be triggered which means that all of the questions of the outstanding survey are rendered “due,” which means that the respondent can be pinged or alerted to the outstanding nature of the survey and be requested to finish each question according to a set timing. In such embodiments, the outstanding survey can be viewed as the baseline assessment between that recipient-respondent pair.

In Step 306, the results of the baseline assessment can be analyzed, and as a result, objectives therefrom can be identified and analyzed. According to some embodiments, the analysis of the baseline assessment can be performed by any type of machine learning (ML) or artificial intelligence (AI) model that can analyze survey data and determine the information provided therein, such as, but not limited to, classifiers, data mining models, neural networks, natural language processors (NLPs), and the like.

In some embodiments, a result of the analysis of the baseline assessment for each recipient-respondent pair can be realized as a determined score for the respondent. In some embodiments, scores can be determined based on the answered question, the unanswered questions, how long answers took to be provided, the content/context of the answer, and the like, or some combination thereof. In some embodiments, the scoring can be specific to a survey, set of surveys, a set of questions, a respondent(s), a recipient(s) and/or a recipient-respondent pair(s), and the like, or some combination thereof. According to some embodiments, scoring of the baseline assessment can be performed via the ML/AI models discussed above, among others, which can provide behavioral data for a respondent and/or their recipient-respondent pair.

In some embodiments, the baseline assessment analysis and scoring can enable the determination of the objectives for each recipient-respondent pair. In some embodiments, the objectives can include, but are not limited to, total utility value, fairness, recency, diversity and minimum number of questions per round.

As discussed below, these objectives can be leveraged to not only determine which questions to ask the respondent’s in the next round, but from which recipient’s the questions should originate from.

According to some embodiments, the total utility value objective corresponds to a number of total questions that have been answered by a respondent. In some embodiments, engine 200 can function to ensure this total utility value for each respondent is maximized so that each survey results in a high response rate.

In some embodiments, engine 200 can determine the utility value by determining a probability that a given respondent will actually answer a question from a given recipient, and multiply this probability by the number of questions given to that respondent. This product is an representation of the utility value.

In some embodiments, the fairness objective corresponds to a variance of the utility of the questions asked in a survey per round. This utility enables the questions to be fairly balanced, which can take into account biographical information, profile information, demographic information, geographic information, employment information (e.g., job title and level) and the like, when determining that questions are fairly balanced across each respondent. In some embodiments, engine 200 can function to ensure this fairness value has a minimized variance level to ensure common types of contextual questions across respondents. Effectively, engine 200 can provide an equitable fairness by ensuring the utility value is the same across users.

In some embodiments, the recency objective corresponds to a time since the recipient has heard from a respondent. This refers to how long it has taken a respondent to answer a survey that included a question(s) from a recipient. In some embodiments, engine 200 can function to ensure this recency value is minimized so that survey’s do not idle or become overdue. For example, reminders, notifications, alerts and/or incentives can be provided to respondents that have not answered questions beyond a threshold amount of time.

In some embodiments, the diversity objective corresponds to a number of different respondents that have provided a recipient with valid answer. In some embodiments, this objective can be a sub-part of the recency objective. In some embodiments, engine 200 can function to ensure that this diversity value is maximized so that more respondents are interacting with a recipient to provide a wider-breadth to the answers being provided to a recipient. In some embodiments, the diversity objective can also refer to a “delta-diversity”, that is, allocate respondents to recipients that have not provided such recipients valid feedback (at least within a threshold period of time), where feedback is considered valid if it addresses the question based on a contextual analysis that the answer’s context corresponds to the questions’ context.

In some embodiments, the minimum number of questions per round objective ensures that each respondent receives at least a minimum predetermined number n questions from their allocated recipient. For example, if respondent A is allocated to give feedback to recipient Y in round XX, engine 200 can allocate a minimum number of n questions between the Y-A pair (e.g., 2 questions, for example).

Having analyzed the identified objectives for each respondent, Process 300 proceeds from Step 306 to Step 308 where the objectives are optimized. According to some embodiments, Step 308 can involve engine 200 utilizing a solver in order to determine a “single verdict” (or representative feedback value) for each respondent. In some embodiments, the solver can be an implementation of any type of known or to be known optimization algorithm, such as, but not limited to, Annealer (which implements simulated annealing), HillClimber, (which implements a numerical analysis algorithm) ExhaustiveSwapper (which implements a bitwise swap operation), Greedy (which implements a greedy algorithm), and the like.

For example, Step 308 can involve using a greedy algorithm on each of the objectives for a respondent in order to optimize the results from the baseline assessment and determine a “single verdict” for that respondent that indicates how the respondent is expected to act in subsequent surveys (or rounds - such that the subsequent questions and/or recipients included in each round can be selected accordingly), as discussed below.

In Step 310, question selection for each respondent is performed. In some embodiments, Step 310 involves determining which questions (e.g., types, topics and/or forms of questions) should be identified for each respondent, and this determination can be based on each respondent’s optimized objectives (from Step 308).

According to some embodiments, each respondent’s score (from Step 306) can be identified and weighted. In some embodiments, the weighting can be randomly applied (e.g., random weights per respondent) by applying a weighted randomness principle. In some embodiments, the weighting can be based on or directly correlate to the representative feedback value (or optimized objectives) of each respondent. For example, the objectives derived for each respondent provide an indication as to the nature of the respondent’s interaction with the survey, the questions included therein, and the recipients that are responsible for those questions. The optimization of these objectives can be leveraged so that the scoring of the respondent can be manipulated to further indicate how they will respond to like or dissimilar types of questions in the future. This, therefore, can be used to select questions to be included in surveys for the respondent’s moving forward.

In some embodiments, the representative feedback value can be weighted by a random value similar to the random weighting discussed above. In some embodiments, the scoring for a respondent can be weighted according to values of each objective (prior to or without them being optimized).

By way of a non-limiting example, questions that a respondent did not answer for a period of time (e.g., they are longer due) or questions that typically elicit the same type of response can be filtered out for that respondent.

Thus, Step 310′s question selection operation involves identifying questions that are more likely to elicit random or different responses from respondents (e.g., different responses per respondent). In some embodiments, the questions that are time sensitive, or have a “dueness” value attributed to them, can also be selected. According to some embodiments, the weighted scoring for a respondent can provide an indication as to which questions map to a respondent’s objectives (e.g., higher weighted scoring can indicate a likelihood that the questions will be answered and that they will elicit responses that are not expected and/or rudimentary, and therefore are compliant with the purposes of the survey).

In Step 312, having identified which questions to select (or having selected the questions, as in Step 310), engine 200 then performs question distribution. In some embodiments, Step 312 involves determines which recipients to have the questions originate from (e.g., who to send the survey). This determination can also be based on the scoring of the respondent and optimization of the objectives for the respondent as it provides an indication of which recipients each respondent is more likely to engage with (e.g., respond in a timely manner with engaging (or contextually relevant and descriptive) answers). According to some embodiments, engine 200 can identify the recipient(s) for a respondent based on a variety of factors, such as, but not limited to, for example, which recipient recently asked a question to the respondent, which recipient recently received a viable response from the respondent, how long were such questions “due,” what were the objective scores for the interactions between recipient-respondent interactions, and the like, or some combination thereof.

In Step 314, having determined the questions (from Step 310) and identified the recipients (from Step 312), engine 200 can compile this information into an electronic survey and communicate an indication to a respondent(s) that a survey is being requested to be completed. In some embodiments, the compiled survey can correspond to the question budget and/or feedback cadence, as discussed above.

In some embodiments, the communication can comprise a link for the respondent to click to cause the survey to be opened. In some embodiments, the survey can be held in abeyance until the user opens the link, whereby the survey can be automatically generated at a time the respondent opens the survey (e.g., questions selected and populated, and recipient’s identified as per Steps 310-312). In some embodiments, the compiled survey can be electronically communicated to the respondents in any electronic form (e.g., email, SMS, and the like). In some embodiments, each recipient that is selected (from Step 312) can also receive a version, copy or indication related to the survey.

According to some embodiments, at the completion of Step 314 (e.g., sending the compiled survey to each respondent), Process 300 can recursively return to Step 306, where the results of the survey can be analyzed in a similar manner as discussed above, whereby the objectives can be updated and Process 300 can function to prepare for subsequent survey rounds (according to the feedback cadence).

FIG. 4 is a block diagram illustrating a computing device 400 showing an example of a client or server device used in the various embodiments of the disclosure. Computing device 400 can be a representation of UE 402, as mentioned above.

The computing device 400 may include more or fewer components than those shown in FIG. 4, depending on the deployment or usage of the device 400. For example, a server computing device, such as a rack-mounted server, may not include audio interfaces 452, displays 454, keypads 456, illuminators 458, haptic interfaces 462, GPS receivers 464, or cameras/sensors 466. Some devices may include additional components not shown, such as graphics processing unit (GPU) devices, cryptographic co-processors, artificial intelligence (AI) accelerators, or other peripheral devices.

As shown in FIG. 4, the device 400 includes a central processing unit (CPU) 422 in communication with a mass memory 430 via a bus 424. The computing device 400 also includes one or more network interfaces 450, an audio interface 452, a display 454, a keypad 456, an illuminator 458, an input/output interface 460, a haptic interface 462, an optional GPS receiver 464 (and/or an interchangeable or additional GNSS receiver) and a camera(s) or other optical, thermal, or electromagnetic sensors 466. Device 400 can include one camera/sensor 466 or a plurality of cameras/sensors 466. The positioning of the camera(s)/sensor(s) 466 on the device 400 can change per device 400 model, per device 400 capabilities, and the like, or some combination thereof.

In some embodiments, the CPU 422 may comprise a general-purpose CPU. The CPU 422 may comprise a single-core or multiple-core CPU. The CPU 422 may comprise a system-on-a-chip (SoC) or a similar embedded system. In some embodiments, a GPU may be used in place of, or in combination with, a CPU 422. Mass memory 430 may comprise a dynamic random-access memory (DRAM) device, a static random-access memory device (SRAM), or a Flash (e.g., NAND Flash) memory device. In some embodiments, mass memory 430 may comprise a combination of such memory types. In one embodiment, the bus 424 may comprise a Peripheral Component Interconnect Express (PCIe) bus. In some embodiments, the bus 424 may comprise multiple busses instead of a single bus.

Mass memory 430 illustrates another example of computer storage media for the storage of information such as computer-readable instructions, data structures, program modules, or other data. Mass memory 430 stores a basic input/output system (“BIOS”) 440 for controlling the low-level operation of the computing device 400. The mass memory also stores an operating system 441 for controlling the operation of the computing device 400.

Applications 442 may include computer-executable instructions which, when executed by the computing device 400, perform any of the methods (or portions of the methods) described previously in the description of the preceding Figures. In some embodiments, the software or programs implementing the method embodiments can be read from a hard disk drive (not illustrated) and temporarily stored in RAM 432 by CPU 422. CPU 422 may then read the software or data from RAM 432, process them, and store them to RAM 432 again.

The computing device 400 may optionally communicate with a base station (not shown) or directly with another computing device. Network interface 450 is sometimes known as a transceiver, transceiving device, or network interface card (NIC).

The audio interface 452 produces and receives audio signals such as the sound of a human voice. For example, the audio interface 452 may be coupled to a speaker and microphone (not shown) to enable telecommunication with others or generate an audio acknowledgment for some action. Display 454 may be a liquid crystal display (LCD), gas plasma, light-emitting diode (LED), or any other type of display used with a computing device. Display 454 may also include a touch-sensitive screen arranged to receive input from an object such as a stylus or a digit from a human hand.

Keypad 456 may comprise any input device arranged to receive input from a user. Illuminator 458 may provide a status indication or provide light.

The computing device 400 also comprises an input/output interface 460 for communicating with external devices, using communication technologies, such as USB, infrared, Bluetooth™, or the like. The haptic interface 462 provides tactile feedback to a user of the client device.

The optional GPS transceiver 464 can determine the physical coordinates of the computing device 400 on the surface of the Earth, which typically outputs a location as latitude and longitude values. GPS transceiver 464 can also employ other geo-positioning mechanisms, including, but not limited to, triangulation, assisted GPS (AGPS), E-OTD, CI, SAI, ETA, BSS, or the like, to further determine the physical location of the computing device 400 on the surface of the Earth. In one embodiment, however, the computing device 400 may communicate through other components, provide other information that may be employed to determine a physical location of the device, including, for example, a MAC address, IP address, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising the steps of:
identifying, by a device, a recipient-respondent pair, the recipient being a user that a set of questions within an electronic survey are asked on behalf of, the respondent being an answering user to the set of questions;
communicating, by the device, a baseline assessment to the respondent within the recipient-respondent pair, the baseline assessment comprising the set of questions and a criteria for each question to be answered by the respondent;
receiving, by the device, feedback to the baseline assessment from the respondent;
analyzing, by the device, the feedback, and determining, based on the analysis, a set of objectives related to the respondent’s feedback;
optimizing, by the device, the determined set objectives into a representative feedback value for the respondent;
determining, by the device, a set of questions and a set of recipients for another electronic survey to be provided to the respondent, the determination of the set of questions and set of recipients based at least on the representative feedback value; and
communicating, by the device, over a network, the other electronic survey to the respondent.

2. The method of claim 1, wherein the set of objectives comprise at least one of a total utility value, fairness value, recency value, diversity value and minimum number of questions per round value.

3. The method of claim 2, wherein the total utility value corresponds to a number of total questions in the baseline assessment that have been answered by the respondent.

4. The method of claim 2, wherein the fairness value corresponds to a variance of a utility of the questions asked in the baseline assessment.

5. The method of claim 2, wherein the recency value corresponds to a time the respondent took to provide the feedback.

6. The method of claim 2, wherein the diversity value corresponds to how many other respondents have answered questions from the recipient.

7. The method of claim 6, wherein the diversity value further comprises a delta-diversity value that corresponds to whether the feedback corresponds to valid answers to the questions, wherein answers are valid when they contextually related to a context of a respective question.

8. The method of claim 1, further comprising:
determining a score for each answer included in the feedback based on the analysis of the feedback, wherein the set of objectives are based on the determined scores; and
weighting the determined scores, wherein the determination of the set of questions and set of recipients is further based on the weighted scores.

9. The method of claim 8, wherein the weighting comprises at least one of randomly applying weights to the scores and applying a weight that corresponds to the representative feedback value.

10. The method of claim 1, further comprising:
identifying a feedback cadence that corresponds to a frequency for requesting electronic survey’s be completed by the respondent, wherein the communication of the other electronic survey complies with the feedback cadence.

11. The method of claim 10, wherein the determination of the set of questions is further based on the feedback cadence.

12. The method of claim 1, further comprising:
identifying a question budget for the respondent, the question budget indicating a number of questions available to be provided to the respondent for a predetermined period of time, wherein the determination of the set of questions is further based on the question budget.

13. The method of claim 1, further comprising:
analyzing the set of objectives based on execution of an optimization algorithm; and
determining, based on the optimization algorithm analysis, the representative feedback value.

14. The method of claim 1, wherein the steps are performed for a set of recipient-respondent pairs.

15. A device comprising:
a processor configured to:
identify a recipient-respondent pair, the recipient being a user that a set of questions within an electronic survey are asked on behalf of, the respondent being an answering user to the set of questions;
communicate a baseline assessment to the respondent within the recipient-respondent pair, the baseline assessment comprising the set of questions and a criteria for each question to be answered by the respondent;
receive feedback to the baseline assessment from the respondent;
analyze the feedback, and determine, based on the analysis, a set of objectives related to the respondent’s feedback;
optimize the determined set objectives into a representative feedback value for the respondent;
determine a set of questions and a set of recipients for another electronic survey to be provided to the respondent, the determination of the set of questions and set of recipients based at least on the representative feedback value; and
communicate, over a network, the other electronic survey to the respondent.

16. The device of claim 15, further comprising:
determine a score for each answer included in the feedback based on the analysis of the feedback, wherein the set of objectives are based on the determined scores; and
weight the determined scores, wherein the determination of the set of questions and set of recipients is further based on the weighted scores.

17. The device of claim 15, further comprising:
identify a feedback cadence that corresponds to a frequency for requesting electronic survey’s be completed by the respondent,
wherein the communication of the other electronic survey complies with the feedback cadence; and
identify a question budget for the respondent, the question budget indicating a number of questions available to be provided to the respondent for a predetermined period of time,
wherein the determination of the set of questions is further based on the feedback cadence and question budget.

18. A non-transitory computer-readable medium tangibly encoded with instructions, that when executed by a processor of a device, perform a method comprising:
identifying, by the device, a recipient-respondent pair, the recipient being a user that a set of questions within an electronic survey are asked on behalf of, the respondent being an answering user to the set of questions;
communicating, by the device, a baseline assessment to the respondent within the recipient-respondent pair, the baseline assessment comprising the set of questions and a criteria for each question to be answered by the respondent;
receiving, by the device, feedback to the baseline assessment from the respondent;
analyzing, by the device, the feedback, and determining, based on the analysis, a set of objectives related to the respondent’s feedback;
optimizing, by the device, the determined set objectives into a representative feedback value for the respondent;
determining, by the device, a set of questions and a set of recipients for another electronic survey to be provided to the respondent, the determination of the set of questions and set of recipients based at least on the representative feedback value; and
communicating, by the device, over a network, the other electronic survey to the respondent.

19. The non-transitory computer-readable medium of claim 18, further comprising:
determining a score for each answer included in the feedback based on the analysis of the feedback, wherein the set of objectives are based on the determined scores; and
weighting the determined scores, wherein the determination of the set of questions and set of recipients is further based on the weighted scores.

20. The non-transitory computer-readable medium of claim 18, further comprising:
identifying a feedback cadence that corresponds to a frequency for requesting electronic survey’s be completed by the respondent,
wherein the communication of the other electronic survey complies with the feedback cadence; and
identifying a question budget for the respondent, the question budget indicating a number of questions available to be provided to the respondent for a predetermined period of time,
wherein the determination of the set of questions is further based on the feedback cadence and question budget.
